(19) United States
(12) Patent Application Publication
(10) Pub. No.: US 2012/0192047 A1
(43) Pub. Date: Jul. 26, 2012

(54) SYSTEMS AND METHODS FOR BUILDING COMPLEX DOCUMENTS

(76) Inventors: David Neil Slatter, Bristol (GB); Darryl Greig, Bristol (GB); Andrew Hunter, Bristol (GB)

(21) Appl. No.: 13/013,635

(22) Filed: Jan. 25, 2011

(51) Int. Cl. G06F 17/00

(52) U.S. Cl. 715/202

(57) ABSTRACT

Systems and methods are provided for building a complex document. A system can include a memory for storing computer executable instructions and a processing unit for accessing the memory and executing the computer executable instructions. The computer executable instructions can include a graphical user interface engine to display a target complex document browser and a plurality of source complex document browsers, such that elements and containers contained within a complex document displayed by each of the source complex document browsers are copyable into the target complex document browser in response to user input information to build a new complex document.

### BACKGROUND

Tools exist for building documents. One such tool for the creation of photo books, greeting cards, calendars and posters features a template approach where each template supports a small number of layout variants. Various decorative themes are available through menus and sidebars. The tool utilizes a single document model and provides interface modes that allow a user to choose from predefined content and content attributes. Other tools employ complex interfaces may require detailed knowledge of a tool to build documents.

### BRIEF DESCRIPTION OF THE DRAWINGS

FIG. 1 illustrates a block diagram of an example graphical user interface for building complex documents.

FIG. 2 illustrates a block diagram of an example complex document.

FIG. 3 illustrates a block diagram of an example system for building complex documents.

FIG. 4 illustrates an example of a multi-level hierarchical data structure associated with a spread.

FIG. 5 illustrates an example of a user copy operation of an image element.

FIG. 6 illustrates an example of a user copy operation of a text element.

FIG. 7 illustrates an example of a user move operation of an image element in a target complex document.

FIG. 8 is an example of a resultant target complex document after the user move operation illustrated in FIG. 7.

FIG. 9 illustrates an example of a user copy operation of a container, its group of elements and underlying layout format.

FIG. 10 is an example of a resultant target complex document after the user copy operation illustrated in FIG. 9.

FIG. 11 illustrates a flow chart of an example method for building a complex document.

### DETAILED DESCRIPTION

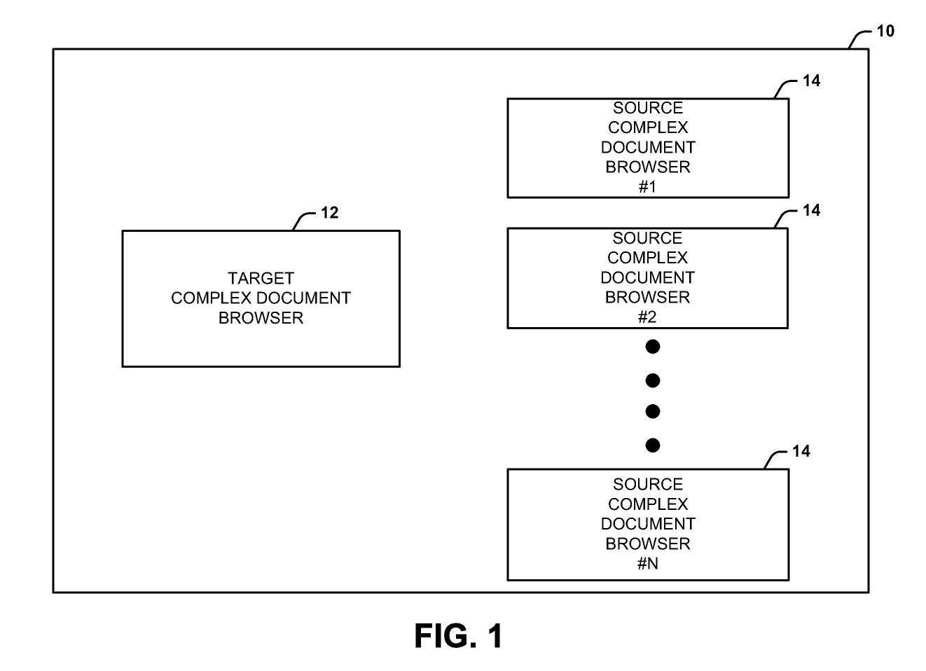

FIG. 1 illustrates a schematic diagram of an example graphical user interface 10 for building complex documents. The graphical user interface (GUI) 10 includes a single user interface window 16 that includes a target complex document browser 12 and a plurality of source complex document browsers 14, labeled source complex document browser #1-source complex document browser #N, where N is an integer greater than equal to one. Displayed within the target complex document browser 12 and each of the plurality of source complex document browsers 14 is an associated complex document. As used herein, a complex document refers to a document that contains a group of elements selected from the group comprising text elements, graphical elements and image elements residing in containers with associated layout formats. An image element is a pixel array, such as, for example, a photo. A graphical element can be a pixel array but may often have a vector representation (e.g. including scalable vector graphics (SVG)). The vector representations are readily scalable without loss of quality. Graphical elements can be used for borders and decoration, logos, diagrams etc. A text element can be a block of text, or a header. Text of a header can include an emphasis such as large text, bolding, underling, etc. and a tag to identify that it is to be put at a top of a layout or first in a layout. The layout of these elements is fully two dimensional, such that it is not restricted to folding a one dimensional thread of characters and images into a fixed column or page. A complex document can also comprise layouts of layouts.

As used herein, the term “includes” means includes but not limited to, the term “including” means including but not limited to. The term “based on” means based at least in part on.

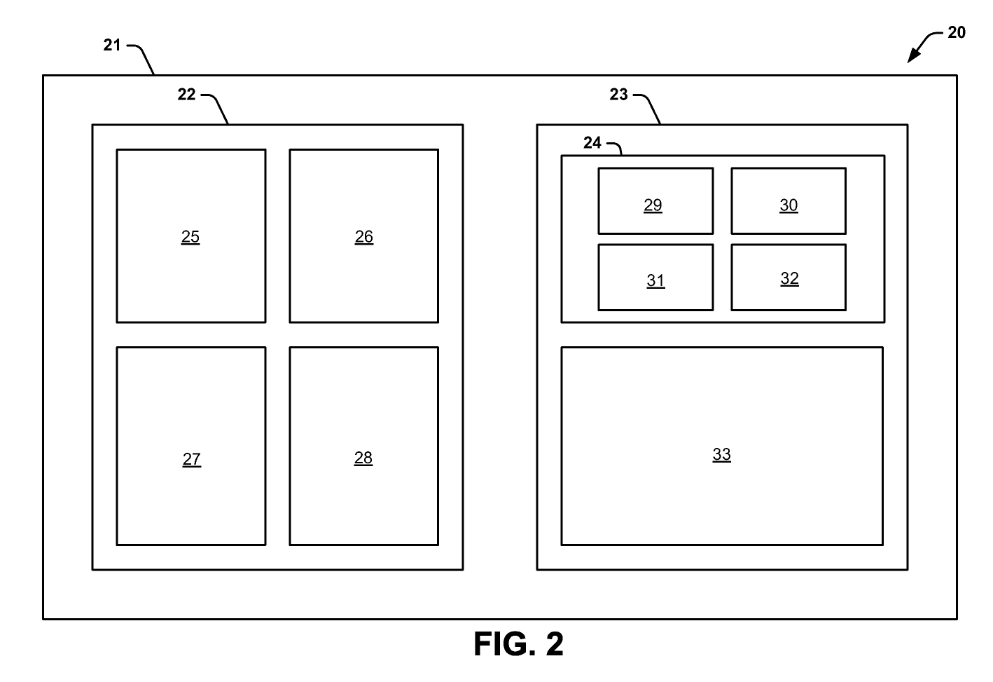

FIG. 2 illustrates an example block diagram of a complex document 20. The complex document 20 includes image elements 25-30 and text elements 31-33. Image elements 29 and 30 and text elements 31 and 32 reside within a grid type layout 24. Image elements 25-28 reside in a first page layout 22. The grid layout 24 and text element 33 reside in a second page layout 23. Pages 22 and 23 reside in a spread layout 21 containing the two pages 22 and 23. Examples of a complex document can be a magazine, a book, a newspaper, a periodical or other publishable type of document. The modifier “source” is intended to indicate that the document is to be used as a source of content. As such, the source complex document can be write-protected upon its creation, such that any part or the entire document can be copied into a target complex document without causing or allowing changes to the source complex document. The copied content can be manipulated and edited within the target complex document.

A complex document is represented for computation by a structure of elements and containers. A container is defined as a group of document elements and a layout format comprising a specific layout engine and layout parameters to be used to arrange these elements. The layout engine arranges and modifies the elements in its container to fill the shape and size of the available surface (e.g., page). Containers can include containers to support complex documents which comprise layouts of layouts. The resulting structure can be described as multi-level hierarchical. Examples of containers include pages, spreads including two facing pages, a group of images, a group of images with titles and others. The results of the container layout operation are displayed in the browser window. Individual text, graphic or image elements can be selectable by pointing to the elements. A container is selectable by pointing at a margin drawn around its elements or a gap between its elements or by a region revealed when the pointer is in the neighborhood of the container's elements. Document creation and editing is accomplished by dragging a selected element or a container on to other elements or containers. Dragging an element on to another element indicates a replace operation. Dragging an element on to a container indicates an operation to add the element to the container. After the container structures have been edited to reflect the user inputs, the container layout engines run and the new arrangement is displayed in the browser window.

An element or container can be selected and copied (e.g., via a pointer drag and drop operation) from the plurality of source complex document browsers 14 to the target complex document browser 12 to allow a user to build a new complex document. An element or container from the plurality of source complex document browsers 14 can be selected and placed over an existing element in the target complex document browser 12, which causes the existing element to be replaced by the copied element or container. A container from the plurality of source complex document browsers can be selected and placed over a container in the target complex document browser, which causes the target complex document container to use its own layout format to layout its existing elements along with the new container. The element or group of elements from the plurality of source complex document browsers 14 can be placed in open spaces corresponding to containers in the target complex document browser 12, which causes the existing elements to be placed into the target complex document associated with the target complex document browser 12.

The elements copied into the target complex document browser 12 can be edited. For example, text in the text element can be deleted and new text added by typing or copying into the text element. The font can be modified in the text element. Additionally, the elements in the target complex document can be copied and/or moved to other locations in the target complex document with existing elements being rearranged based on the layout engine of the container. The elements in the source complex document browsers 14 may be restricted such that the elements can be copied and not moved or edited in the source complex document browsers 14.

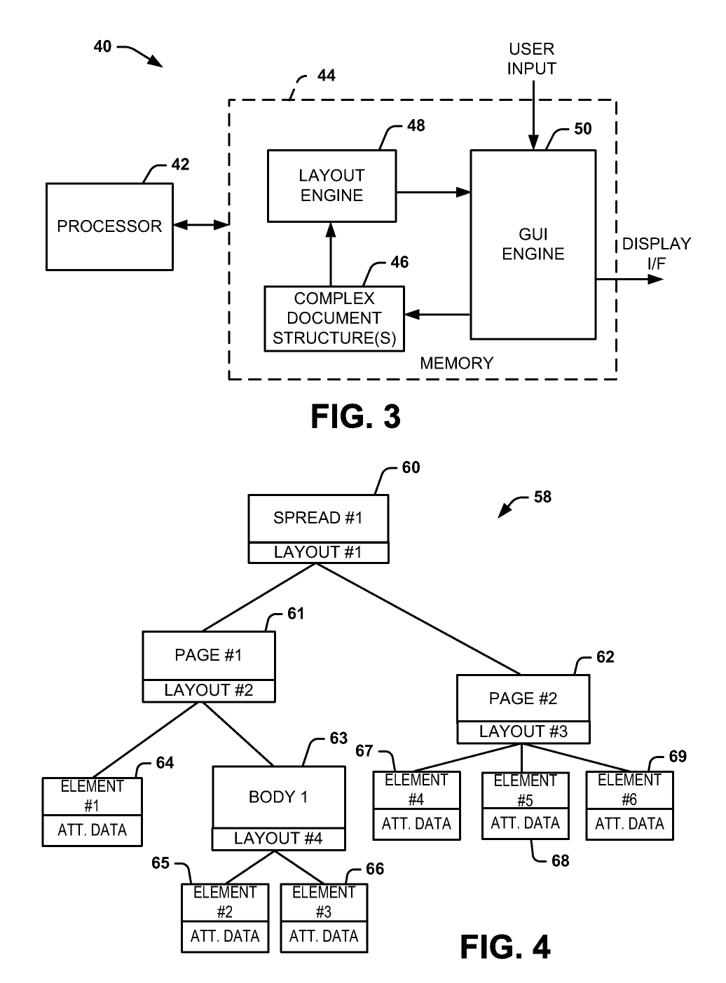

FIG. 3 illustrates a block diagram of an example system 40 for building complex documents. The system 40 includes a processing unit 42 and memory 44. Memory 44 can be implemented as a computer readable medium, such as random access memory (RAM), non-volatile memory, etc. Memory 44 includes computer executable components and/or instructions in the form of a graphical user interface engine 50 and a layout engine 48. The memory also includes a plurality of complex document element data structures 46 with each data structure representing a complex document to be displayed in browsers in a GUI displayed on a display. The processing unit 42 can access memory 44 and retrieve and update the data structures and also execute the computer executable components and/or instructions. The GUI engine 50 provides instructions to a display interface for displaying on a display a single user interface window that includes a target complex document browser and a plurality of source complex document browsers. Displayed within the target complex document browser and each of the plurality of source complex document browsers is an associated complex document that is displayed based on an associated complex document element data structure and an associated document layout defined by the layout engine 48.

The GUI engine 50 receives user input information locally or remotely, such as selecting and copying elements from the source complex document browsers to the target complex document browser, moving objects within the target complex document browser and flipping through pages of complex documents in the different complex document browsers. The GUI engine 50 then instructs the display interface to display the graphical operations to the user, such as selecting, dragging and dropping of graphical objects associated with the different elements. The display can be located local or remote from the GUI engine 50. The GUI engine 50 provides edits to the complex document structures 46 with user input information when an element has been added to or moved within the target complex document within the target complex document browser. The layout engine 48 then processes the modified complex document element data structure associated with the target complex document and determines a layout constrained by the layout engine 48 to arrange the elements on a page or spread of the complex document. The arrangement may be statistically determined based on, for example, minimizing white space on a page or spread. The GUI engine 50 receives the layout instruction from the layout engine 48 and instructs the rearrangement of the elements associated with the different elements to be displayed on the display. A similar process occurs when a user provides an indication of moving elements within the target complex document.

FIG. 4 illustrates an example of a multi-level hierarchical data structure 58 corresponding to a spread. The data structure 58 can be represented as a binary tree having a plurality of container nodes 60-63 and a plurality of content nodes 64-69. In the example of FIG. 4, the content nodes 64-69 are implemented as leaf nodes corresponding to the container nodes 60-63. Each of the content elements includes associated attribute data, such as component type, component authorship and component revenue or cost. A given complex document can be formed of multiple spreads, which may be the same or different depending on the layout format of the container.

In the example of FIG. 4, the spread 60 includes a Layout Format #1, a first page container node 61 (“Page 1”) that includes a Layout Format #2 and a second page container node 62 (“Page 2”) that includes a Layout Format #3. The first and second page container nodes 61 and 62 are associated with the first and second pages, respectively, of the spread. Branching from the container node 61 are a leaf node 64 (Element #1) and another container node 63 (“Body 1”). The container node 63 includes a Layout Format #4 and further includes two child content nodes 65 and 66, demonstrated as Element #2 and Element #3. The container node 62 includes three child leaf content nodes 67-69, demonstrated as Element #4, Element #5 and Element #6. Each layout format can be fixed or dynamic. A dynamic format includes a layout engine and associated layout parameters that layouts elements within a container employing a statistical model or some other model. The example of FIG. 4 demonstrates but one example of a hierarchical representation for a spread that can be implemented in source complex document or a target complex document. Various other structures and content can be utilized based on the teachings herein.

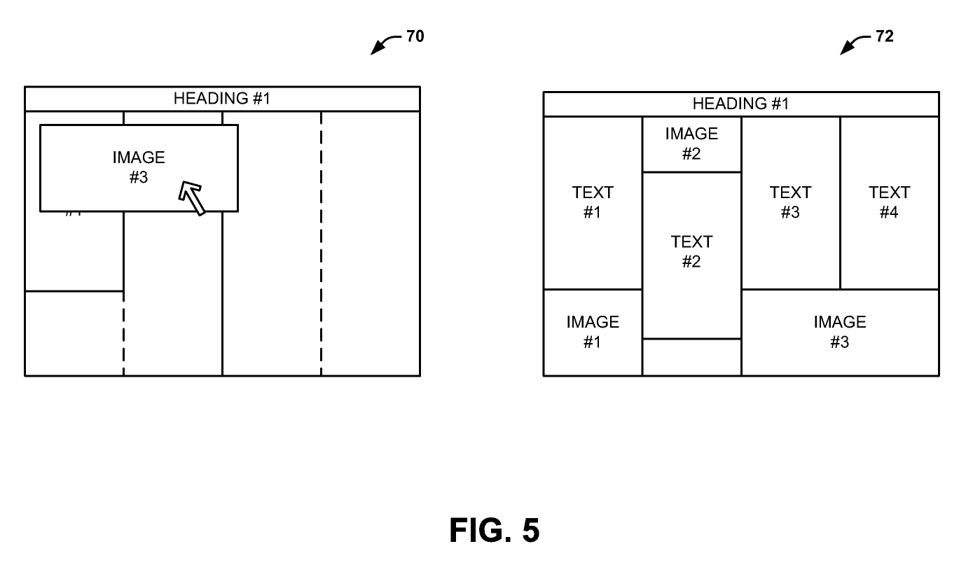

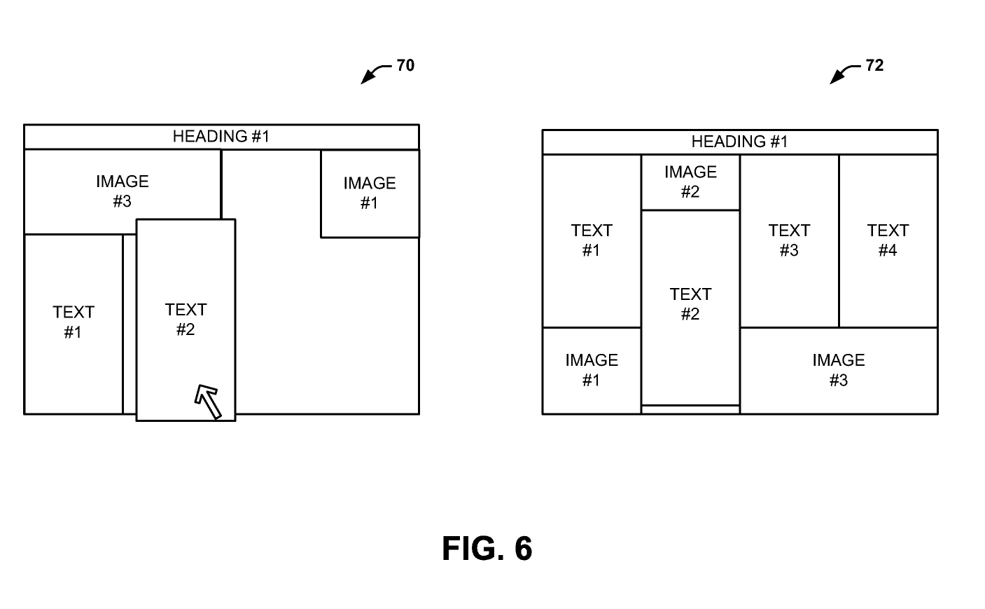

FIGS. 5-10 illustrate portions of a graphical user interface that show different user operations for building complex documents. FIG. 5 illustrates an example of a user copy operation of an image element. A copy of an image element #3 is dragged via a pointer from a source complex document 72 over a portion of a target complex document 70 in which a user desires to insert the image element #3. The target complex document 70 has a column container format over a two page spread, as illustrated by the dashed lines. Dropping the image element #3 into the container causes the layout engine to run to accommodate the extra component. The result of the layout is illustrated in document 70 of FIG. 6, where the image element #3 has moved into both the upper portion of the first column and a second column of the spread while the text element #1 has moved to a lower portion of the first column of the spread.

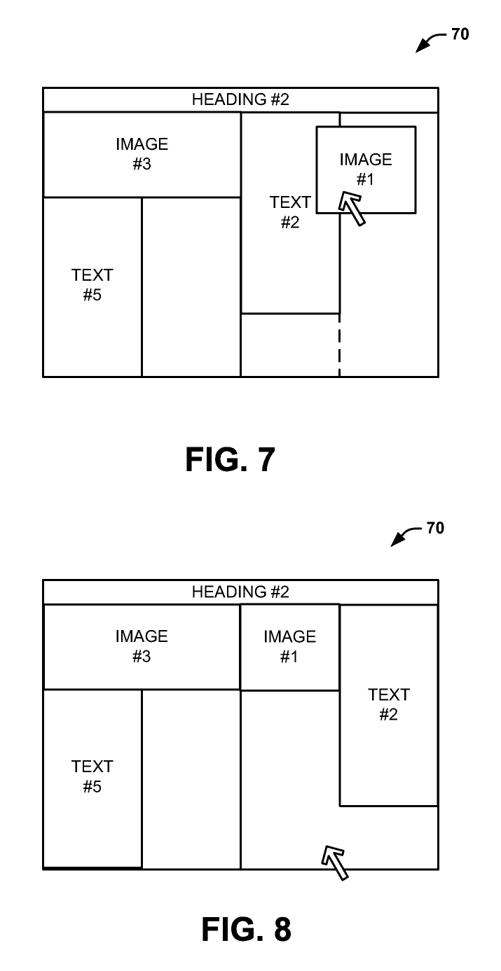

FIG. 6 also illustrates an example of a user copy operation of a text element. A copy of a text element #2 is dragged via a pointer from the source complex document 72 over a lower portion of the second column of the spread of the target complex document 70. The layout engine automatically moves text element #2 to an upper portion of a third column of the spread as shown in FIG. 7. Alternatively, the layout engine can move a portion of the text element #2 that does not fit within the open space of the second column of the spread into the second column of the spread. Additionally, the text in text heading element #1 has been edited to form text heading element #2 and the text in text element #1 had been edited to form text element #5.

FIG. 7 illustrates an example of a user move operation of an image element in the target complex document 70. The image element #1 is dragged over an upper portion of text element #2. As illustrated in FIG. 8, the image element #1 is dropped into the upper portion of the third column of the spread while the text element #2 is automatically moved to an upper portion of a fourth column of the spread. Alternatively, the image element #1 and/or text element #2 can be resized within certain defined limits, such that both the image element #1 and text element #2 can be displayed within the third column of the spread.

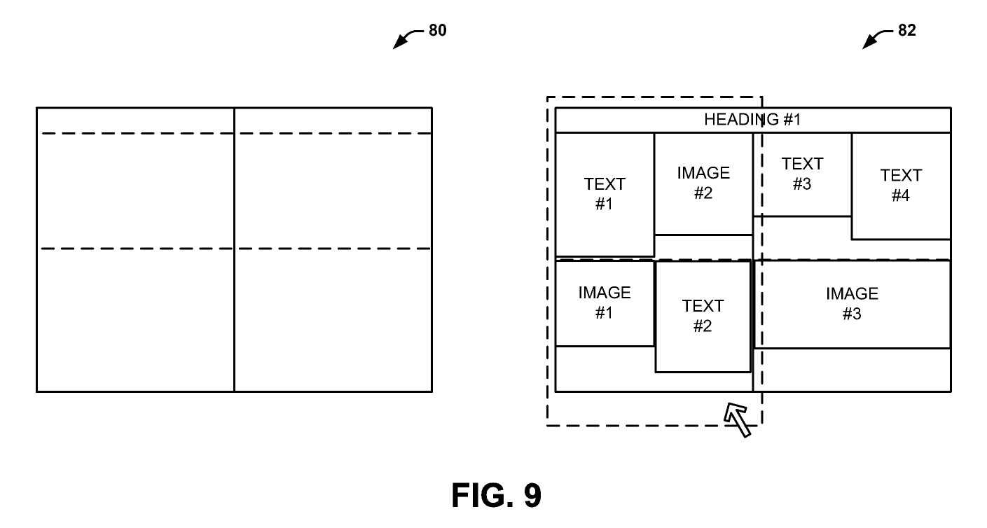

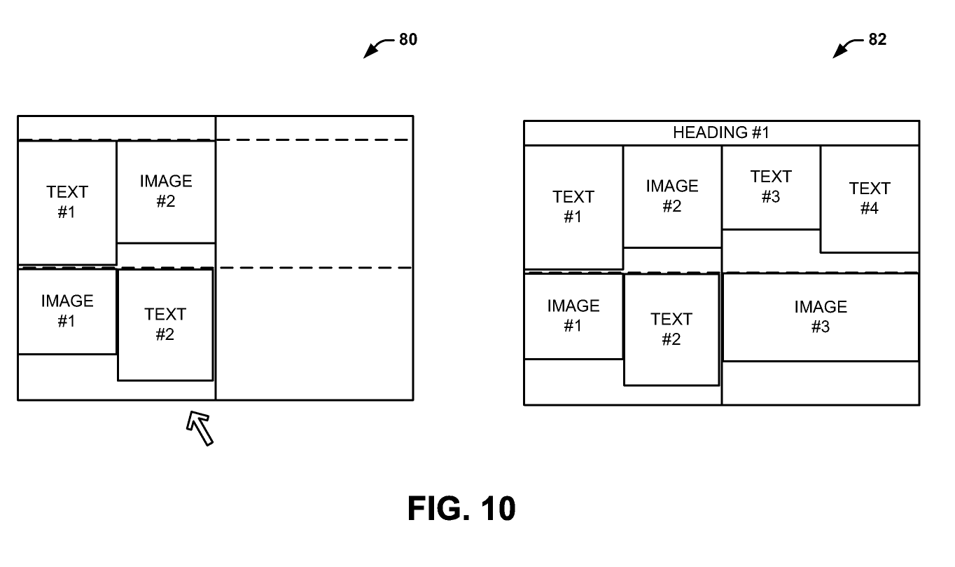

FIG. 9 illustrates an example of a user copy operation of a container, its elements and layout format. A user selects a container from a source complex document 82 and drags and drops it over the target complex document 80. The container along with its group of elements and underlying layout format is copied into the first page of a spread of the target complex document 80, as illustrated in FIG. 10.

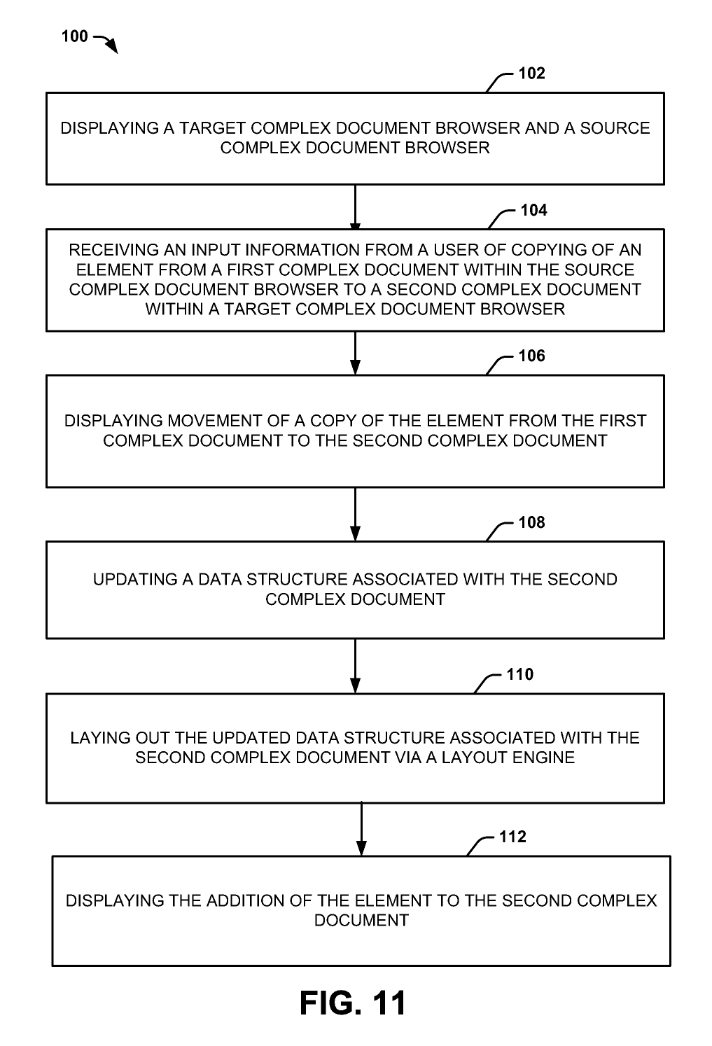

In view of the foregoing structural and functional features described above, an example methodology will be better appreciated with reference to FIG. 11. While, for purposes of simplicity of explanation, the example method of FIG. 11 is shown and described as executing serially, it is to be understood and appreciated that the present example is not limited by the illustrated order, as some actions could in other examples occur in different orders and/or concurrently from that shown and described herein.

FIG. 11 illustrates a flow chart of an example method 100 for building a complex document. The method 100 could be executed, for example, by processor. At 102, a target complex document browser and a source complex document browser are displayed. At 104, user input information is received from a user of copying of an element from a first complex document within the source complex document browser to a second complex document within a target complex document browser. At 106, movement of a copy of the element from the first complex document to the second complex document is displayed. At 108, a data structure associated with the second complex document is updated to add the copied element. At 110, the updated complex document structure is processed by the layout engine. At 112, the addition of the copied element to the second complex document is displayed.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system for building complex documents, the system comprising:
a memory for storing computer executable instructions; and
a processing unit for accessing the memory and executing the computer executable instructions, the computer executable instructions comprising:
a graphical user interface engine to display a target complex document browser and a plurality of source complex document browsers, such that elements and containers contained within a complex document displayed by each of the source complex document browsers are copyable into the target complex document browser, in response to user input information, to build a new complex document.

2. The system of claim 1, wherein the elements are not editable when in the source complex documents browsers and the elements are editable when in the target complex document browser.

3. The system of claim 1, wherein elements of a given container are copied with the given container upon selecting and copying of the given container from one of the plurality of source complex document browsers to the target complex document browser.

4. The system of claim 3, wherein the layout format of the container is copied along with the given container upon selecting and copying of the given container from the one of the plurality of source complex document browsers to the target complex document browser

5. The system of claim 1, wherein the elements are image elements, graphical elements and text elements.

6. The system of claim 1, wherein the complex documents are multi-spread documents, the graphical user interface engine providing functionality to flip through the pages of the multi-spread documents in the plurality of source complex document browsers and the target complex document browser.

7. The system of claim 1, wherein the complex documents are stored as multi-level hierarchical data structures.

8. The system of claim 1, further comprising a layout engine to automatically arrange elements copied from the complex documents within the plurality of source complex document browsers to the complex document within the target complex document browser with existing elements in the complex document within the target complex document browser.

9. A method for building complex documents, the method comprising:
displaying a target complex document browser and a source complex document browser within a single user interface window;
receiving input from a user of copying of an element from a first complex document within the source complex document browser to a second complex document within the target complex document browser;
displaying movement of a copy of the element from the first complex document to the second complex document;
updating a data structure associated with the second complex document to add the copied element;
laying out the updated data structure via a layout engine; and
displaying the addition of the copied element to the second complex document.

10. The method of claim 9, further comprising:
receiving input from a user of editing of the copied element in the second complex document within the target complex document browser;
updating the data structure associated with the second complex document; and
displaying the editing of the element within the second complex document.

11. The method of claim 9, further comprising:
displaying the replacement of an existing element within the second complex document with the copy of the element from the first complex document to the second complex document.

12. The method of claim 9, further comprising:
receiving input from a user of copying of another element from a third complex document within another source complex document browser to the second complex document within the target complex document browser;
displaying movement of a copy of the another element from the third complex document to the second complex document;
updating a data structure associated with the second complex document to add the copied another element;
laying out the updated data structure via a layout engine; and
displaying the addition of the copied another element to the second complex document.

13. A computer readable medium having computer executable instructions comprising:
a graphical user interface engine to display a target complex document browser and a plurality of source complex document browsers within a single user interface window, such that graphical elements, text elements, image elements and containers along with the containers elements and layout formats contained within a complex document displayed by each of the source complex document browsers are copyable into the target complex document browser to build a new complex document: and
a layout engine to automatically arrange copied elements copied from the complex documents within the plurality of source complex document browsers with existing elements in the complex document within the target complex document browser.

14. The computer readable medium of claim 13, wherein the complex documents in both the target complex document browser and source complex document browsers are multi-spread documents stored as multi-level hierarchical data structures, the graphical user interface engine provides functionality to flip through the pages of the multi-spread documents in the plurality of source complex document browsers and the target complex document browser.

15. The computer readable medium of claim 14, wherein the elements are not editable when in the source complex documents browsers and the elements are editable when in the target complex document browser.
